(19) United States
(12) Patent Application Publication
(10) Pub. No.: US 2025/0230832 A1
(43) Pub. Date: Jul. 17, 2025

(54) SCREW CONNECTION

(71) Applicant: LIEBHERR-WERK BIBERACH GMBH, Biberach an der Riss (DE)

(72) Inventors: Timo MÖLLER, Westhausen (DE); Robert BRAMBERGER, Biberach an der Riss (DE); Torsten WINDORFER, Biberach an der Riss (DE)

(21) Appl. No.: 18/854,432

(22) PCT Filed: Apr. 6, 2023
(86) PCT No.: PCT/EP2023/059221

§ 371 Date: Oct. 4, 2024

(30) Foreign Application Priority Data
Apr. 14, 2022 (DE) 10 2022 109 187.2

(51) Int. Cl. F16B 31/02; G01L 5/00

(52) U.S. Cl. CPC F16B 31/028; G01L 5/0028

(57) ABSTRACT

The invention relates to a screw connection, which comprises a screw body with an external thread, a mating piece with an internal thread which is matched to the external thread and into which the screw body is screwed, a spacer sleeve for clamping between a screw head of the screw body and the mating piece, and a sensor system which is configured to determine a stress state acting in the screw body. The sensor system comprises a transmitter, which is arranged in the spacer sleeve, and a receiver, which is arranged in the spacer sleeve, wherein the transmitter is configured to convert electrical energy into mechanical surface waves, the receiver is configured to convert mechanical surface waves into electrical energy, and the sensor system is further configured to draw conclusions about the stress state acting in the screw body and/or the spacer sleeve.

The present invention relates to a screw connection and to a construction machine, for example a crane, comprising a screw connection of this kind.

Any screw connection is subject to setting force loss. This is understood to mean a plastic change in length of the screw and the parts braced thereby. It occurs because the components of the screw connection have a certain surface roughness, but this is flattened when tightening the screw connection, leading to the load on the connecting parts being relieved. This relaxing is referred to as the setting force loss. In addition to the setting force loss, any screw connection is also subject to a certain amount of material fatigue, which develops over its service life and likewise entails a reduction in the preload force.

When dimensioning a screw connection, the setting force loss and the material fatigue have to be taken into account, but this often involves the screw connection being overdimensioned. Furthermore, it is necessary to change or re-tighten screws and nuts after a certain time interval has elapsed for consistent safety of the screw connection.

So-called load cells, which are used to monitor preload forces of a screw connection, are known from the prior art. In this case, a resistive measurement method is generally used, in which the force of the screw connection results in deformation, which is detected by a strain measurement technique and is evaluated by corresponding processing electronics. If the force exerted on a load cell by a screw connection changes, this is interpreted as the tension force loss, and therefore appropriate countermeasures can be taken.

In particular, it is a drawback here that the measuring bridge arranged in the load cell needs to be dimensioned in a performance-based manner and is thus only taken into consideration for a particular application scenario.

Another drawback of the load cells known from the prior art is that their response behaviour is rather slow and cutoff frequencies in the range of 10 Hz already constitute a technological challenge. Load cells which use the resistive measurement method are therefore in particular not suitable for highly dynamic systems.

The continuing miniaturisation of the load cell is also problematic when using the resistive measurement method, since it requires a certain minimum extent owing to the measurement principle used.

In addition to the resistive measurement method, so-called acoustic emission testing is also known from the prior art. This purely passive method is generally used for composite materials and takes advantage of the fact that, when there are sudden changes in the structure of a material (cracks or the like), for example caused by a mechanical load, an acoustic emission is generated, which can be detected by a corresponding receiver component. The analysis of the received acoustic emission then allows a conclusion to be drawn about the structural integrity of the material or component. A drawback here is that changes in the force effect on a material that do not lead to a change in structure cannot be accurately detected. A setting force loss of a screw connection cannot be detected using the acoustic emission testing known from the prior art.

The object of the present invention is to overcome or at least lessen the above-mentioned drawbacks in order to provide an improved screw connection. Advantageously, it should be capable of determining a stress state of the screw connection.

This is made possible by a screw connection which has all the features of claim 1. The invention further relates to a construction machine, in particular a crane, which contains the screw connection according to the invention. Advantageous configurations of the present invention are found in the dependent claims.

In this case, a screw connection according to the invention comprises a screw body comprising an external thread, a mating piece, in particular a screw nut, comprising an internal thread which is matched to the external thread and into which the screw body is screwed, a spacer sleeve for clamping between a screw head of the screw body and the mating piece, and a sensor system which is configured to determine a stress state acting in the screw body. The invention is characterised in that the sensor system comprises a transmitter, which is arranged in the spacer sleeve, and also comprises a receiver, which is arranged in the spacer sleeve, wherein the transmitter is configured to convert electrical energy into mechanical surface waves, the receiver is configured to convert mechanical surface waves into electrical energy, and the sensor system is further configured to draw conclusions about the stress state acting in the screw body and/or the spacer sleeve on the basis of the change in the emitted mechanical surface waves in relation to the received mechanical surface waves.

According to the invention, it is therefore provided that conclusions can be drawn about the stress state of the screw or about the force that is acting on the spacer sleeve by means of an active acoustic measurement technique. Unlike in the acoustic emission analysis known from the prior art, according to the invention a mechanical surface wave is actively induced in the component and its (reflected) response is analysed. The reflected wave contains information regarding the structural excitation of the spacer sleeve, such that conclusions can be drawn about a force that is acting (or the stress state of the screw).

In this case, it can be provided that, owing to the structural damping of the spacer sleeve which is present owing to the acting force of the screw connection, the transmitted mechanical surface waves are subject to a characteristic change, which allows a conclusion to be drawn about the stress state.

By means of the principle of actively transmitting mechanical surface waves, highly dynamic change processes can also be detected in the stress state which clearly outperform the response behaviour of conventional resistive measurement methods.

According to an optional development of the invention, it can be provided that the transmitter and the receiver of the sensor system are each a ferroelectric element, in particular a piezoelectric element. In particular, a piezoelectric element works well for generating mechanical surface waves, wherein there is advantageously a materially bonded connection between the component in which the mechanical surface waves are to be induced and the piezoelectric element, such that the transmission of the waves into the component or from the component to the piezoelectric element is coupled in or out without major losses.

According to another optional modification to the present invention, it can be provided that the transmitter is configured to induce mechanical surface waves at the spacer sleeve and/or the receiver is configured to receive mechanical surface waves from the spacer sleeve and convert them into corresponding electrical signals.

The transmitter is accordingly configured to convert electrical signals into a mechanical surface wave from the spacer sleeve, wherein, accordingly, the receiver is configured to receive a reflected mechanical surface wave from the spacer sleeve and convert it into a corresponding electrical signal.

Advantageously, according to the invention it is provided that the transmitter and/or the receiver are arranged in the spacer sleeve in a materially bonded manner. In this case, it can be provided that both the transmitter and the receiver are surrounded by the spacer sleeve on all sides such that the transmitter and/or the receiver are embedded in or attached to the material of the spacer sleeve. This is particularly advantageous because embedding the transmitter and the receiver means that no other external housing is required for protecting them, which simplifies the handling of the screw connection according to the invention.

According to an optional development of the present invention, it can be provided that the sensor system is configured to determine a change in the stress state in the spacer sleeve and/or the screw body on the basis of a change in the wave characteristics between the transmitted mechanical surface waves and the received mechanical surface waves.

By comparing the properties of the transmitted surface wave with the received surface waves, a conclusion can be drawn about a change in the stress state of the spacer sleeve (and thus also the screw body). For this purpose, the sensor system can comprise an analysis unit, which performs the above-described comparison and can draw a conclusion about a setting force loss or the like from the detected differences in the wave characteristics.

In this case, it can for example be provided that the wave characteristics take into account a wave amplitude, a propagation frequency, a quality factor, a relative phase position and/or the dominant oscillation mode.

According to a development of the invention, it can also be provided that the mechanical surface waves are structure-borne sound waves, in particular Rayleigh waves.

Here, Rayleigh waves are particularly suitable for the present invention, since they obtain very good quality in terms of results.

According to a variant of the present invention, it can also be provided that the sensor system is further configured to analyse a group propagation speed of a wave, an upper envelope and/or a lower envelope of a wave, in particular a structure-borne sound wave, in order to draw conclusions about a changed stress state of the spacer sleeve and/or the screw body.

For example, the evaluation of the group propagation speed of a structure-borne sound wave can be interpreted as structural damping by means of the miniaturised application of the experimental modal analysis. In addition, the structural damping can be divided into an analysis of an upper envelope and a lower envelope, such that both quasi-static and dynamic state changes can be evaluated very rapidly.

According to another optional modification of the present invention, it can be provided that the propagation frequency of the mechanical surface waves emitted by the transmitter is in the range of 20 kHz to 20 MHz and/or the amplitude of the mechanical surface waves emitted by the transmitter is in the range of a few nanometres to a few picometres.

It is clear to a person skilled in the art that the wave signal emitted by the transmitter is time-variant and can assume different patterns, in order to draw a conclusion on a state change.

According to a development of the invention, it can also be provided that the transmitter and/or the receiver are embedded in the spacer sleeve, preferably are surrounded by the material of the spacer sleeve on all sides.

According to the invention, it can advantageously be provided that the sensor system is configured to determine the stress state of the spacer sleeve and/or the screw body in a frequency of at least 1 kHz, preferably in a frequency of at least 3 kHz, preferably in a frequency of at least 8 KHz.

These high frequencies thus allow for a rapid reaction to a detected state change of the screw connection. This rapid reaction time is an essential advantage for being able to take countermeasures in good time should the sudden loosening of the screw connection or a similar situation be detected.

According to the present invention, it can also be provided that a measuring path in the surface of the spacer sleeve directly adjoins the transmitter and/or the receiver, which measuring path is preferably recessed relative to the other regions of the spacer sleeve in its surface topology, in particular by providing a groove which defines the measuring path and of which the edge regions result in the surface waves being reflected, wherein the interior of the groove is preferably recessed relative to the edge regions and, according to an optional configuration, has a polished-smooth surface.

In this case, it can be provided that the measuring path is arranged between the transmitter and the receiver and the receiver is positioned at one end of the measuring path and the transmitter is positioned at the other end. This is not necessarily required, however, since positioning the transmitter and the receiver at the same end of the measuring path also provides the desired functionality.

According to another optional development of the invention, it can be provided that the sensor system is further configured to send a signal to a monitoring unit when a variation in the stress state of the spacer sleeve and/or the screw body is detected that is above a certain threshold value, preferably in order to initiate appropriate countermeasures.

The invention further relates to a construction machine, in particular a crane, comprising at least one screw connection according to any one of the preceding claims, wherein signalling of the necessity for maintenance is based on the stress state of the spacer sleeve and/or the screw body determined by the sensor system.

As a result, it is no longer necessary to adhere to rigid maintenance intervals, and instead maintenance can be carried out as required.

The invention further relates to a crane comprising at least one screw connection according to any one of the variants discussed above, wherein a load table for permissibly performing a load lift using the crane is stored in a control unit and the control unit is configured to update the load table on the basis of the at least one determined stress state of the spacer sleeve and/or the screw body, wherein the at least one screw connection preferably connects mast sections or boom elements of the crane.

Using the screw connection according to the invention, structural-dynamic borderline cases can be detected and monitored. This makes it possible to adjust a load table to the actual performance level of the crane, which can decrease over the duration of use of the crane, for example.

Further features, details and advantages of the invention are clear from the description of the figures, in which:

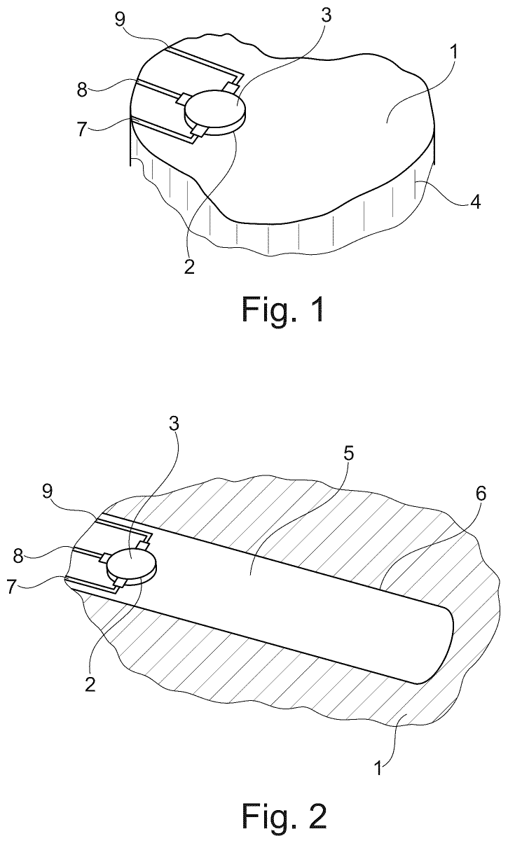

FIG. 1 is a partial view of the spacer sleeve of the screw connection according to the invention,

FIG. 2 is a partial view of the spacer sleeve of the screw connection according to the invention according to another embodiment, and

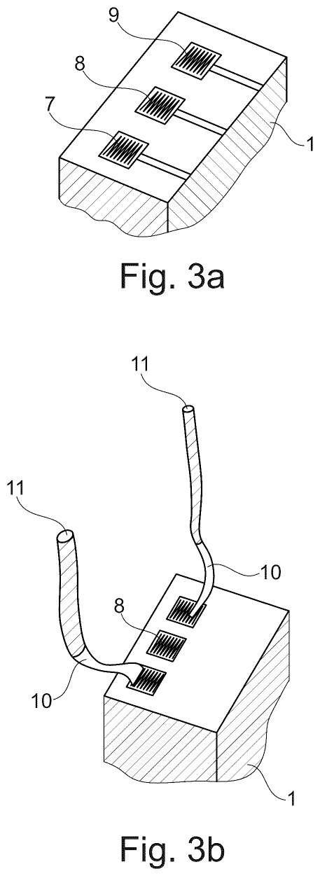

FIG. 3a/3b each show the possible connection of the transmitter and/or the receiver in the spacer sleeve.

FIG. 1 is a partial view of the spacer sleeve 1 of the screw connection according to the invention. This shows the transmitter 2, which is arranged in a sandwich construction together with the receiver 3. In this case, both the transmitter 2 and the receiver 3 are connected to a corresponding electrical line 7, 9, via which the electrical signal is supplied and conducted away. Furthermore, a ground connection 8 is also provided, which extends to the transceiver unit.

The transmitter 2, which is for example a piezoelectric element, is excited by means of an electrical signal carried to the transmitter 2 via the line 7 and causes a mechanical surface wave on the spacer sleeve 1. This then propagates in the material 4 of the spacer sleeve 1 and is at least partially reflected back to the receiver 3. Owing to the structural damping of the spacer sleeve 1, different characteristics of the transmitted surface wave are changed in a specific manner on the basis of a force acting on the spacer sleeve 1, such that a decreasing force effect on the spacer sleeve I can be identified in the variation in the received surface wave.

The converter properties of the material 4 of the spacer sleeve 1 are dependent, inter alia, on a minimum particle size and the corresponding particle size distribution, the hardness, in particular the microhardness, the toughness and ductility and the homogeneity, texture and structure. The material 42CrMo4 in particular meets corresponding requirements, and it is therefore particularly suitable as the material 4 for a spacer sleeve 1.

FIG. 1 shows the particularly space-saving sandwich construction of the transmitter 2 and the receiver 3, in which the transmitter 2 is only separated from the receiver 3 by a thin film, but the two components are arranged one above the other.

It is clear to a person skilled in the art that a different construction is also covered by the present invention in which, for example, the transmitter 2 has a greater spatial distance from the receiver 3. In this case, it can further be provided that the receiver 3 receives signals from the transmitter 2 which originate on a direct propagation path from the transmitter 2 and have not just found the path to the receiver 3 by reflection.

FIG. 2 shows another embodiment, in which a measuring path 5 on which the surface waves propagate is provided in order to improve the signal quality. In this case, the measuring path comprises edge regions 6, which constitute reflection boundaries for the surface waves. The reflection boundaries thus define a geometric region for the propagation area of the surface waves in which the waves are influenced by the structural dynamics of the spacer sleeve 1.

Here, the measuring path 5 can be sunk down relative to the rest of the topology of the spacer sleeve in the manner of a groove and also has a polished-smooth surface.

FIG. 3a shows a first wired option for connecting the line 7 leading to the transmitter 2 and the line 9 leading to the receiver 3. It shows a contact surface for the connections (line 7, ground connection 8 and line 9) that can be contacted by a wired connection. The provision 5 of the signals for exciting the transmitter 2 and for evaluating the received signals by the receiver 3 can then take place in a downstream unit, which no longer necessarily has to be integrated in the spacer sleeve.

FIG. 3b shows another option for the connection of the transmitter 2 and the receiver 3, wherein they are configured to be wireless. Each instance of reference sign 10 characterises an antenna element, which is part of the antenna assembly 11. This figure shows dipole antennas. which form a feed line for the transmitter 2 and the receiver 3. It is simpler to mount a spacer sleeve of this kind, since it is no longer necessary to manually contact wired conductors.

LIST OF REFERENCE SIGNS
1 Spacer sleeve
2 Transmitter
3 Receiver
4 Material of the spacer sleeve
5 Measuring path
6 Edge region of the measuring path
7 Electrical line to the transmitter
8 Ground connection
9 Electrical line from the receiver
10 Antenna element
11 Antenna assembly

1. Screw connection, comprising:
a screw body comprising an external thread,
a mating piece comprising an internal thread which is matched to the external thread and into which the screw body is screwed,
a spacer sleeve for clamping between a screw head of the screw body and the mating piece, and
a sensor system which is configured to determine a stress state acting in the screw body, wherein
the sensor system comprises a transmitter, which is arranged in the spacer sleeve, and a receiver, which is arranged in the spacer sleeve, wherein
the transmitter is configured to convert electrical energy into mechanical surface waves,
the receiver is configured to convert mechanical surface waves into electrical energy, and
the sensor system is further configured to draw conclusions about the stress state acting in the screw body and/or the spacer sleeve on the basis of the change in the emitted mechanical surface waves in relation to the received mechanical surface waves.

2. Screw connection according to claim 1, wherein the transmitter and the receiver of the sensor system are each a ferroelectric element.

3. Screw connection according to claim 1, wherein the transmitter is configured to induce mechanical surface waves at the spacer sleeve and/or the receiver is configured to receive mechanical surface waves from the spacer sleeve.

4. Screw connection according to claim 1, wherein the transmitter and/or the receiver are arranged in the spacer sleeve in a materially bonded manner.

5. Screw connection according to claim 1, wherein the sensor system is configured to determine a change in the stress state in the spacer sleeve and/or the screw body on the basis of a change in the wave characteristics between the transmitted mechanical surface waves and the received mechanical surface waves.

6. Screw connection according to claim 5, wherein the wave characteristics take into account a wave amplitude, a propagation frequency, a quality factor, a relative phase position and/or the dominant oscillation mode.

7. Screw connection according to claim 1, wherein the mechanical surface waves are structure-borne sound waves.

8. Screw connection according to claim, wherein the sensor system is further configured to analyse a group propagation speed, an upper envelope and/or a lower envelope of a wave in order to draw conclusions about a changed stress state of the spacer sleeve and/or the screw body.

9. Screw connection according to claim 6, wherein the propagation frequency of the mechanical surface waves emitted by the transmitter is in the range of 20 kHz to 20 MHz and/or the amplitude of the mechanical surface waves emitted by the transmitter is in the range of a few nanometres to a few picometres.

10. Screw connection according to claim 1, wherein the transmitter and/or the receiver are embedded in the spacer sleeve.

11. Screw connection according to claim 1, wherein the sensor system is configured to determine the stress state of the spacer sleeve and/or the screw body in a frequency of at least 1 kHz.

12. Screw connection according to claim 1, wherein a measuring path in the surface of the spacer sleeve directly adjoins the transmitter and/or the receiver, which measuring path is recessed relative to the other regions of the spacer sleeve in its surface topology.

13. Screw connection according to claim 1, wherein the sensor system is further configured to send a signal to a monitoring unit when a variation in the stress state of the spacer sleeve and/or the screw body is detected that is above a certain threshold value in order to initiate appropriate countermeasures.

14. Construction machine comprising at least one screw connection according to claim 1, wherein signalling of the necessity for maintenance is based on the stress state of the spacer sleeve and/or the screw body determined by the sensor system.

15. Crane comprising at least one screw connection according to claim 1, wherein a load table for permissibly performing a load lift using the crane is stored in a control unit and the control unit is configured to update the load table on the basis of the at least one determined stress state of the spacer sleeve and/or the screw body.

16. Screw connection according to claim 1, wherein the mating piece is a screw nut.

17. Screw connection according to claim 2, wherein the ferroelectric element is a piezoelectric element.

18. Screw connection according to claim 10, wherein the transmitter or the receiver are embedded in the spacer sleeve so as to be surrounded by the material of the spacer sleeve on all sides.

19. Screw connection according to claim 12, wherein the measuring path is recessed relative to the other regions of the spacer sleeve in its surface topology by providing a groove which defines the measuring path and of which the edge regions result in the surface waves being reflected, wherein the interior of the groove is recessed relative to the edge regions and is polished smooth.

20. Crane according to claim 15, wherein the at least one screw connection connects mast sections or boom elements of the crane.
